(19) United States
(12) Patent Application Publication
(10) Pub. No.: US 2026/0300332 A1
(43) Pub. Date: Oct. 1, 2026

(54) AUTOMATED WORKFLOW GENERATION USING MACHINE LEARNING

(71) Applicant: eBay Inc., San Jose, CA (US)

(72) Inventors: Shiwam Mittal, Santa Clara, CA (US); Muthaiyan Thandapani, Tracy, CA (US)

(73) Assignee: eBay Inc., San Jose, CA (US)

(21) Appl. No.: 19/093,904

(22) Filed: Mar. 28, 2025

(51) Int. Cl. G06F 16/3329; G06F 16/332; G06F 16/34

(52) U.S. Cl. CPC G06F 16/3329; G06F 16/3322; G06F 16/34

(57) ABSTRACT

Automated workflow generation techniques are described. In one or more examples, a user interface is provided having at least one option configured to enter plain-language text specifying generation of a workflow to achieve a result and a prompt is generated based on the plain-language text. The prompt references information describing a component repository of reusable workflow modules for executing tasks, one or more instructions for creating the workflow, and usage criteria for the reusable workflow modules based on the plain-language text. A workflow is received from a language model as describing a logical order and dependencies between a set of the reusable workflow modules.

### BACKGROUND

Workflows are usable to plan achievement of a result through a sequence of tasks. Workflows may be utilized to support a variety of functionalities, including project management, healthcare, human resources, finance, software development, and so forth.

Conventional workflow generation techniques, however, face several technical challenges. Conventional workflow generation techniques, for instance, may involve extensive domain expertise and manual effort to design and optimize workflows which is generally performed in “one-off” scenarios. Reliance on specialized knowledge and manual inputs leads to a time-consuming and error-prone processes with corresponding inefficiencies in computational resource utilization. These conventional workflow generation techniques also struggle with scalability and as such are not able to efficiently handle complex workflows with numerous components or interdependencies as is common in typical real-world scenarios.

### SUMMARY

Automated workflow generation techniques using machine learning are described. In the techniques described herein, a workflow manager system employs reusable workflow modules and a language model (e.g., a large language model (LLM)) to generate optimized workflows through machine learning. The workflow generation system utilizes machine learning and reusable workflow modules to create optimized, executable workflows from natural language inputs as plain-language text. A language model is leveraged to interpret user requests and generate workflows by selecting and connecting reusable workflow modules.

The workflow generation system is configurable to construct prompts that incorporate task schemas describing operation of the reusable workflow modules and workflow description data. By processing the prompt, the language module is configured to identify reusable workflow module dependencies, optimize for parallel execution, and creates transformation layers to ensure compatibility. The workflow generation is also configurable to generate a visualization of the workflow to present the workflows graphically. In this way, the techniques described herein support accurate and rapid creation of complex, efficient workflows across various domains, reducing manual coding and ensuring scalability and adaptability to changing requirements.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ automated workflow generation techniques using machine learning as described herein.

FIG. 2 depicts a system in an example implementation showing operation of a workflow manager system of FIG. 1 in greater detail as generating reusable workflow modules.

FIG. 3 is a flow diagram depicting an algorithm as a step-by-step procedure in an example implementation of operations performable for accomplishing a result of reusable workflow module generation.

FIG. 4 depicts a system in an example implementation showing operation of a workflow manager system of FIG. 1 in greater detail as generating a workflow by a language model based on tasks supported by reusable workflow modules of FIG. 2.

FIG. 5 depicts an example of plain-language text as an input that is used to generate a prompt for processing by a language model and a workflow output by the language model.

FIG. 6 depicts an example of a prompt for processing by a language model that includes text from a task schema.

FIG. 7 depicts an example of generation of an executable workflow architecture using a set of reusable workflow modules as specified by a workflow generated in FIG. 4.

FIG. 8 is a flow diagram depicting an algorithm as a step-by-step procedure in an example implementation of operations performable for accomplishing a result of workflow generation based on tasks supported by reusable workflow modules.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

### Overview

Conventional workflow generation and optimization techniques face significant technical challenges across various domains, including software development, construction, general process management, and so forth. Conventional techniques, for instance, often rely on sequential arrangement of tasks without consideration for optimization, manual planning, and specialized knowledge resulting in inefficient workflows.

As a result, conventional techniques encounter several technical challenges. In a first example, conventional techniques involve significant investment and effort to understand and manually optimize workflows, which is often neglected due to time constraints. In a second example, conventional techniques provide limited visibility of component relationships thereby making it difficult for developers or process managers to fully comprehend the system architecture. In a third example, workflow component may rely on different input and output types, thereby creating challenges in manually determining an optimal order and connections between components.

Due to the complexity and time-consuming nature of manual optimization of conventional techniques, developers and process managers often resort to suboptimal solutions, sacrificing efficiency for expediency. These technical problems result in inefficient resource utilization, extended project timelines, and missed opportunities for parallelization and optimization in workflow execution and thus suboptimal use of computational resources.

Accordingly, automated workflow generation techniques using machine learning are described. In the techniques described herein, a workflow manager system employs reusable workflow modules and a language model (e.g., a large language model (LLM)) to generate optimized workflows through machine learning, e.g., as part of generative artificial intelligence (AI). These techniques enable the workflow manager system to intelligently analyze and arrange the reusable workflow modules in an optimized order, significantly reducing execution time, compared to conventional linear approaches, with improved accuracy.

The workflow manager system, for instance, may employ a database of reusable workflow modules, each representing a specific task with defined inputs and outputs. The workflow manager system, for example, may collect a task schema describing operation of the reusable workflow modules that describes inputs, outputs, dependencies, tasks performed when executed, and so forth. Then, the workflow manager system receives an input of workflow description data (e.g., via a user interface) describing a workflow to be created. The workflow description data, for instance, describes a result to be achieved, parameters associated with the result, and so forth. The workflow manager system then generates one or more prompts to a language model to generate a workflow based on the workflow description data and the task schema describing operation of the workflow modules.

A language model (e.g., LLM) is employed by the workflow manager system to generate the workflow through processing of the one or more prompts. In this way, the language model is used by the workflow manager system to understand relationships and dependencies between the reusable workflow modules and associated tasks based on the associated task schema and workflow description data. The language model, for instance, is usable to identify a set of the reusable workflow modules associated with tasks usable to achieve a result specified in the workflow description data.

The language module is also configurable (through this or another prompt) to generate interconnections between the set of reusable workflow modules. The language model, for instance, is usable to determine an efficient arrangement and potential parallelization opportunities. As a result, the language model reduces and even eliminates manual optimization, making the workflow generation process less time-consuming and reducing a likelihood of developers resorting to suboptimal solutions and errors introduced by conventional manual approaches.

As part of forming the interconnections, the language module is also configurable to specify inclusion of a translation layer between reusable workflow modules, as appropriate, to ensure data compatibility based on the task schemas. In this way, the workflow manager system implements a standardized approach to workflow optimization that is applicable across various domains, from software development to physical construction projects, providing a unified solution to workflow generation challenges as further described below.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of language machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Automated Workflow Generation Environment

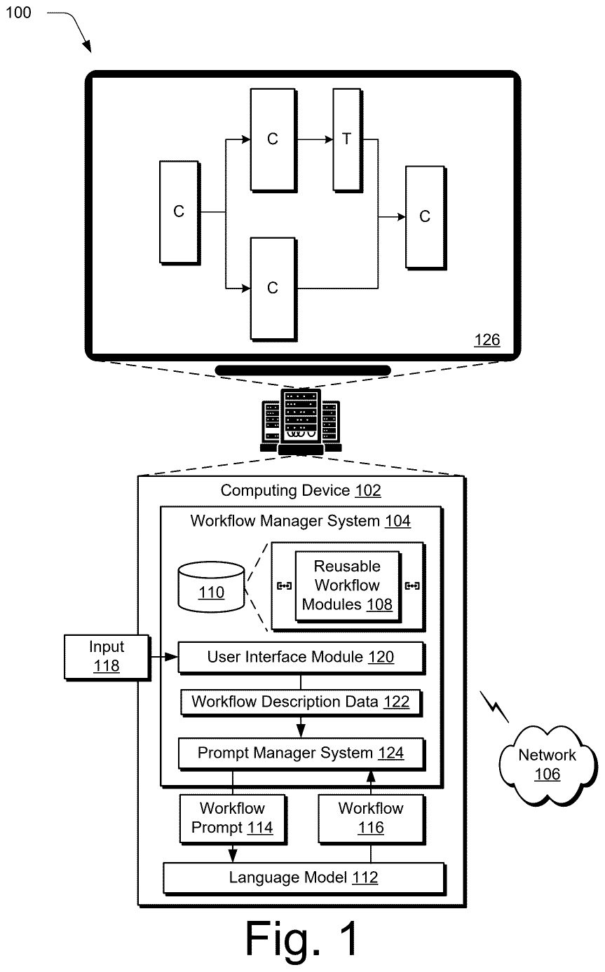

FIG. 1 is an illustration of a digital medium environment 100 in an example implementation that is operable to employ automated workflow generation techniques using machine learning as described herein. The illustrated environment 100 includes a computing device 102, which is configurable in a variety of ways.

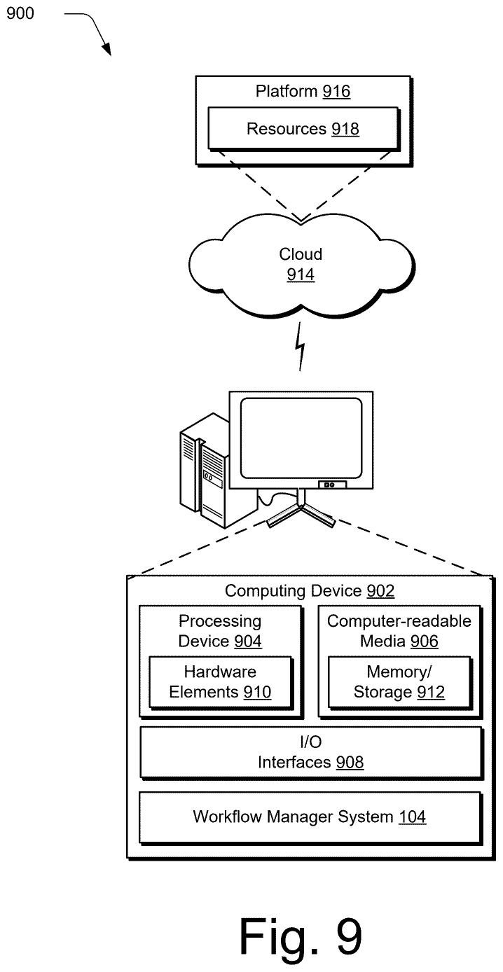

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources, e.g., mobile devices. Additionally, although a single computing device is shown and described in instances in the following discussion, a computing device is also representative of a plurality of different devices, such as multiple servers utilized by a business to perform operations “over the cloud” as further described in relation to FIG. 9.

The computing device 102 includes a workflow manager system 104 that is implemented using hardware and software resources, e.g., a processing device and computer-readable storage medium. Although implementation of the workflow manager system 104 and language model is illustrated as performed locally at the computing device 102, implementation of the workflow manager system 104 and/or language model 112 (e.g., as a large language model (LLM)) may be performed remotely, e.g., as one or more digital services accessible via a network 106.

The workflow manager system 104 is configurable to leverage a plurality of reusable workflow modules 108, which are illustrated as being stored in a database 110 by a storage device. Each of the plurality of reusable workflow modules 108 is executable to perform a task that together may be used to achieve a desired result of a workflow. A reusable workflow module 108 for a house construction project, for instance, may be configured for a task to “install electrical wiring.” This reusable workflow module 108 is therefore executable to plan the task of installing electrical wiring. To do so, this reusable workflow module 108 takes as input a house blueprint, electrical plan, and a list of materials and from this configures a user interface to indicate instructions to be performed to complete an associated task.

The reusable workflow module 108, for instance, may output a series of instructions for display in a user interface, such as marking wiring routes on walls and ceilings, drilling holes for cable passages, running cables through walls and ceilings, installing junction boxes and outlets, connecting wires to the main electrical panel, and performing initial safety tests. This reusable workflow module 108 may also define dependencies, such as specifying that a “Frame Walls” reusable workflow module 108 is to be completed before execution of the “install electrical wiring” module. The “install electrical wiring” reusable workflow module 108 is also configurable to specify output parameters, such as a completed wiring diagram and a checklist of installed components. As a result, this reusable workflow module 108 may be readily integrated into different house construction workflows, allowing for standardization and optimization of the electrical installation process across various projects.

The workflow manager system 104 is configurable in this example to leverage the reusable workflow modules 108 in implementing a workflow, which is generated using machine learning, e.g., as part of generative artificial intelligence (AI). An input 118, for instance, is received by a user interface module 120 to generate workflow description data 122. The workflow description data 122 describes a result to be achieved by the workflow, e.g., to build a house, to code an application, and so forth.

The workflow description data 122 is then processed by a prompt manager system 124 to generate a workflow prompt 114 that is compatible with a language machine-learning model, which is illustrated as language model 112. The workflow prompt 114, for instance, is configurable to include a task schema that describes operational parameters of respective reusable workflow modules 108. In this way, the workflow prompt 114 provides insights to the language model 112 about tasks available to be performed by the reusable workflow modules 108 as well as how the reusable workflow modules 108 do so.

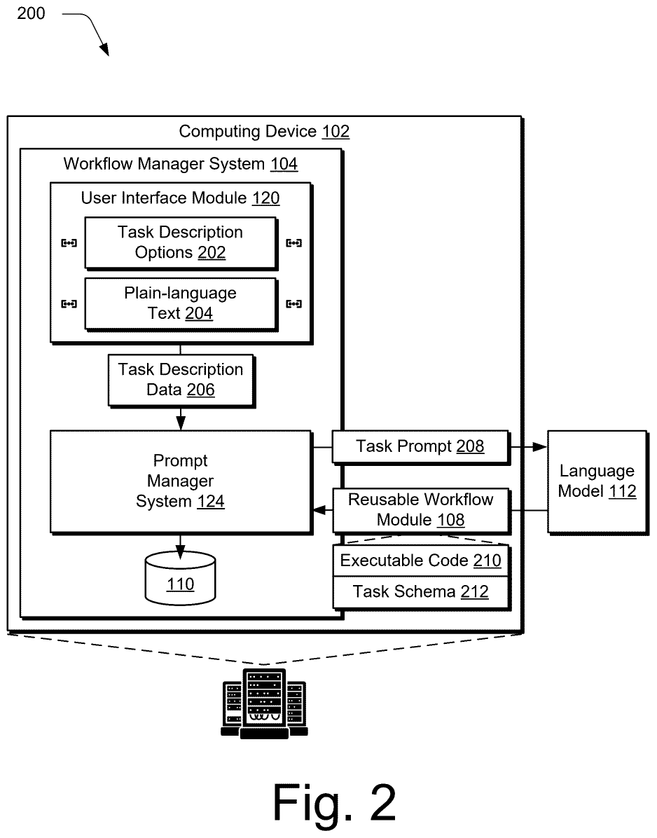

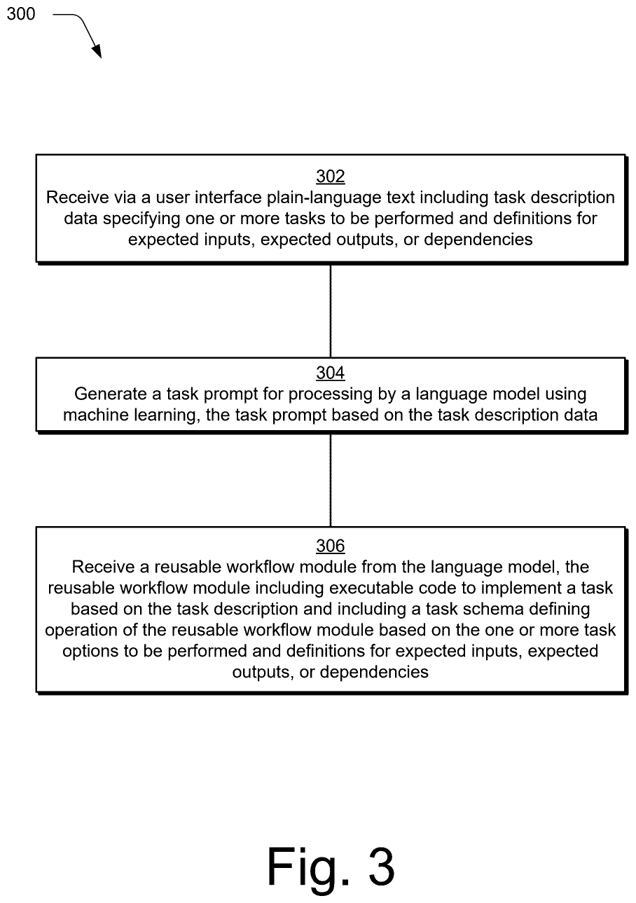

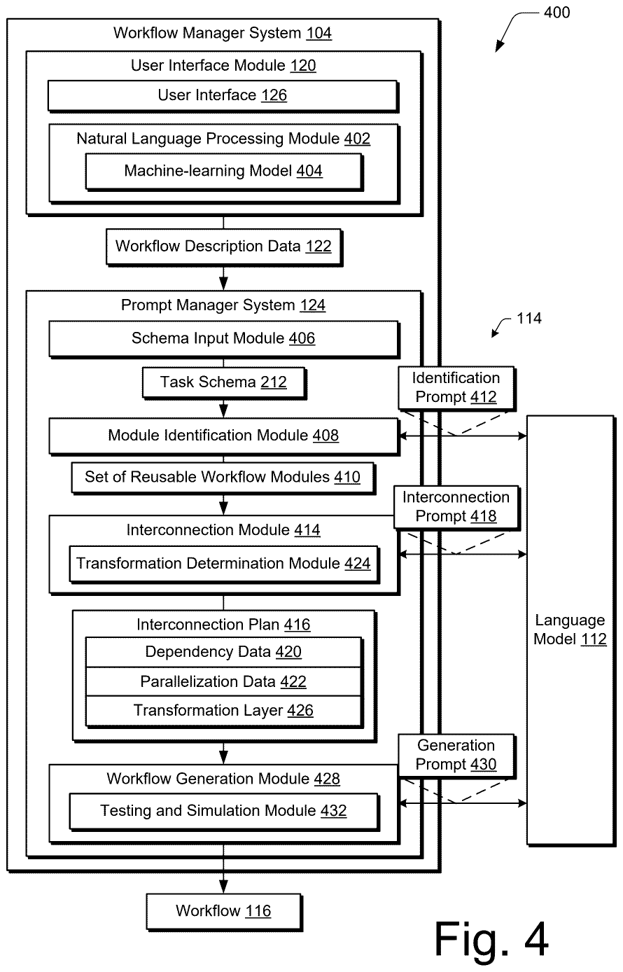

The task schema, along with the workflow description data 122, is then passed by the prompt manager system 124 as a workflow prompt 114 to the language model 112. In response, the language model 112 generates a workflow 116 to achieve a result specified by the workflow description data 122 using a set of the reusable workflow modules 108. The workflow manager system 104 may then output a visualization as shown in the user interface 126 of FIG. 1 that includes representations of respective reusable workflow modules 108, interconnections between the modules, transformation layers employed, and so forth. In this way, a user that provided the input 118 is provided with a detailed insight into the operation of the workflow 116. In the illustrated example, for instance, a user is readily informed as to parallelization employed in the workflow, which reusable workflow modules are used, identifies use of a transformation layer, and so forth which is not possible in conventional techniques. Further discussion of these and other examples is included in the following discussion, including reusable workflow module 108 generation as described in relation to FIGS. 2 and 3, and workflow generation as described in relation to FIGS. 4-8.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Reusable Workflow Module Generation

The following discussion describes reusable workflow module generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 2 depicts a system 200 in an example implementation showing operation of the workflow manager system 104 of FIG. 1 in greater detail as generating reusable workflow modules 108. FIG. 3 is a flow diagram depicting an algorithm 300 as a step-by-step procedure in an example implementation of operations performable for accomplishing a result of reusable workflow module generation. In portions of the following discussion, reference is made in parallel to FIGS. 2 and 3.

To begin this discussion at FIG. 2, a user interface module 120 receives via a user interface 126 an input 118 as plain-language text. The plain-language text includes task description data specifying one or more tasks to be performed and definitions for expected inputs, expected outputs, or dependencies (block 302). The user interface module 120, for instance, may output task description options 202 that are user selectable and/or support entry of plain-language text 204 to form task description data 206. The task description data 206 identifies steps, operations, and a desired task that is to be performed by a respective reusable workflow module.

In an example in which the reusable workflow module is to be executable, itself, to perform the task the plain-language text describes operations to be performed as part of the task. The input 118, for instance, may be configured as plain-language text as “Create a Python script that reads data from a CSV file, calculates the average of a specified numeric column, and outputs the result to a new text file. The script is to handle errors if the file is not found or if the specified column does not exist. Allow user input of the CSV filename, column name, and output filename as command-line arguments.” This input specifies multiple steps to be performed to complete the task, including reading from a CSV file, performing calculations, writing to a new file, implementing error handling, and accepting user inputs.

In another example, the reusable workflow module is executable to output steps to guide performance of the task. The input 118, for instance, may be configured as plain-language text of “Generate a step-by-step guide for output in a user interface to install electrical wiring in a new house. The guide is to cover safety precautions, tools and materials, planning the wiring layout, running cables through walls and ceilings, installing junction boxes and outlets, connecting to the main electrical panel, and performing initial safety tests. Include warnings about local building codes and when to consult a professional electrician. The output is to be in a format that can be easily displayed on a mobile device for reference during the installation process.”

Therefore, in this example the input specifies multiple task options to be performed, including safety considerations, resource planning, physical installation steps, and compliance with regulations. The workflow manager system 104 may process this natural language request to generate executable code that produces a structured, user-friendly guide for electrical wiring installation, potentially leveraging reusable workflow modules for content organization, safety protocol integration, and formatting for various output devices. A variety of other examples are also contemplated.

A prompt manager system 124 is then employed in this example to generate a task prompt 208 for processing by a language model 112 using machine learning. The task prompt is generated based on the task description data 206 (block 304). The prompt manager system 124, for instance, may forward the task description data 206 “as is” and/or modify the task description data 206 (e.g., expand the description) for processing by the language model 112. The prompt manager system 124, in one or more examples, receives task description data 206 specifying: “Perform a task to analyze customer feedback data from multiple sources, identify common themes, and generate a summary report with actionable insights.” The prompt manager system 124 in this example then automatically expands this input to form a task prompt 208 by adding context and specific instructions for the language model 112.

The expanded task prompt 208, for example, may include details such as: “Using natural language processing techniques, analyze customer feedback data from social media posts, email surveys, and customer support tickets. Identify recurring themes and sentiments across each of the data sources. Generate a comprehensive summary report that highlights a top five most frequent customer concerns, provides quantitative data on sentiment trends, and suggests actionable recommendations for improving customer satisfaction. The task includes data preprocessing steps, sentiment analysis, topic modeling, and report generation components. Consider scalability for processing large volumes of data and provide options for visualizing the results.” Thus, in this example the expanded task prompt 208 increases guidance to the language model 112 for generating a reusable workflow module 108.

The task prompt 208, in one or more examples, includes instructions to cause the language model 112 to generate the reusable workflow module 108 to include executable code 210 and a task schema 212 describing operation of the reusable workflow module 108 being generated. The executable code 210, for instance, is executable to perform the task itself, executable to output instructions in a user interface for steps involved in performing the task, and so forth.

In the illustrated example, the prompt manager system 124 receives the reusable workflow module 108 from the language model 112. The reusable workflow module 108 includes the executable code 210 to implement a task based on the task description. The reusable workflow module 108 also includes and includes a task schema 212 defining operation of the reusable workflow module based on the one or more task options to be performed and definitions for expected inputs, expected outputs, or dependencies (block 306). The reusable workflow module 108 is then stored in the database 110 for use in implementing respective workflows as further described in relation to FIGS. 4-8.

The use of reusable workflow modules 108 in supporting a workflow 116 supports significant technical advantages and increases computing device efficiency. By leveraging pre-built, optimized reusable workflow modules 108 for common tasks, the workflow manager system 104 can reduce redundant code generation and minimize processing overhead. For example, a reusable workflow module 108 for data parsing may implement efficient algorithms that significantly decrease the time involved in processing large datasets. Similarly, a reusable workflow module 108 for database interactions may incorporate connection pooling and query optimization techniques, reducing memory usage and improving response times. Reusable workflow modules 108 for parallel processing may enable automatic distribution of tasks across multiple cores or nodes, maximizing hardware utilization.

In another example, the reusable workflow module 108 may incorporate caching mechanisms, reducing repeated computations and database queries and corresponding increases in computational resource efficiency. Thus, by combining these reusable workflow modules 108, the workflow manager system 104 may achieve substantial reductions in overall execution time, memory consumption, and CPU usage compared to generating bespoke solutions for each workflow. Additionally, the modular approach may facilitate easier updates and maintenance, allowing performance improvements to be propagated across multiple workflows with minimal effort. Further discussion of these and other examples is included in the following section and shown in corresponding figures.

### Example Workflow Generation Based on Reusable Workflow Modules

The following discussion describes workflow generation techniques that leverage reusable workflow modules that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

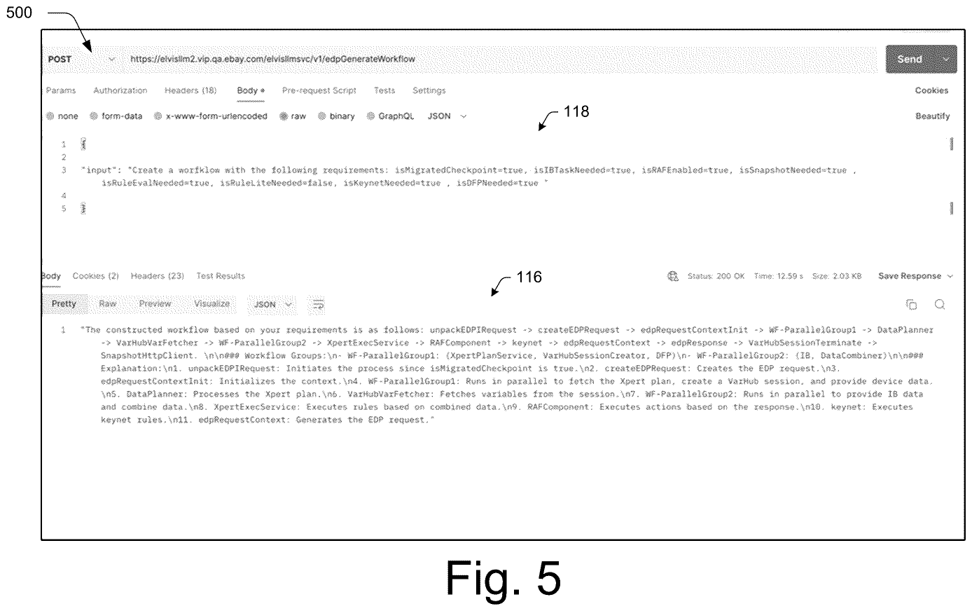

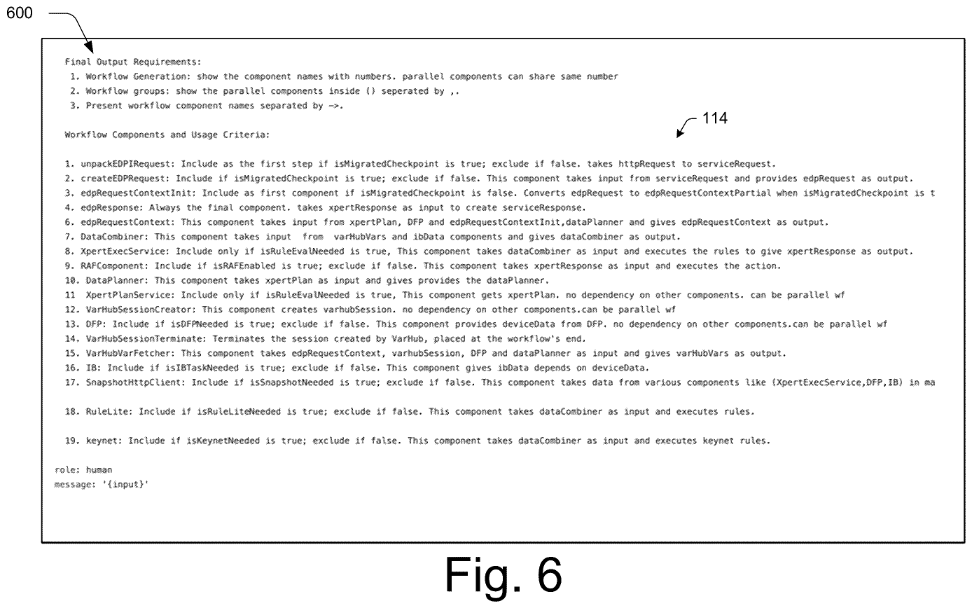

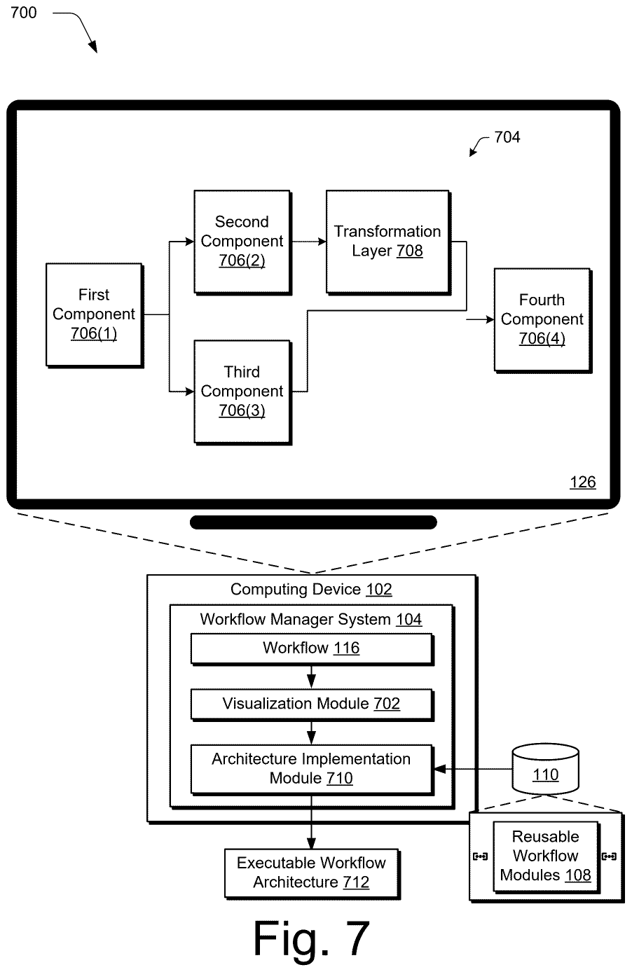

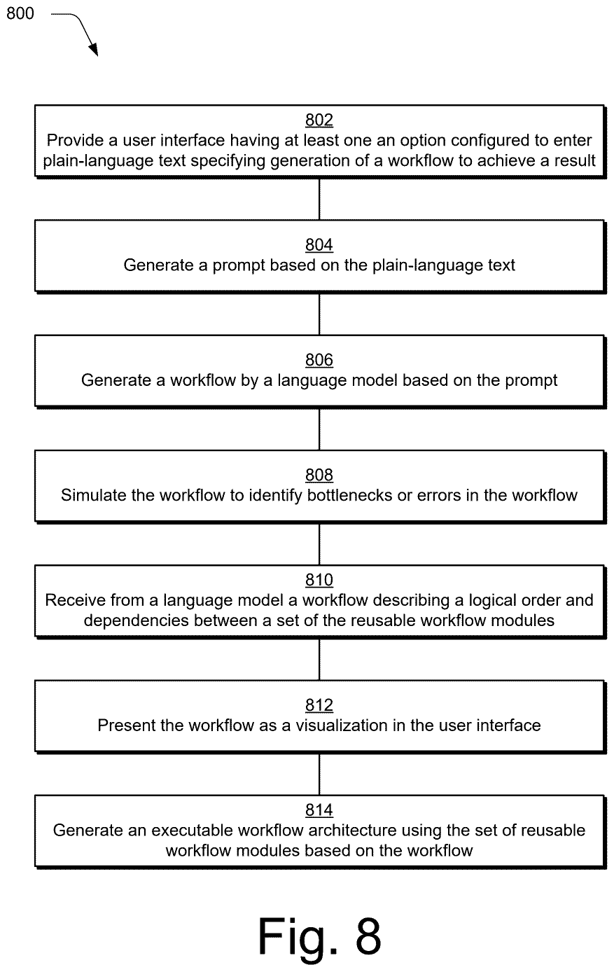

FIG. 4 depicts a system 400 in an example implementation showing operation of the workflow manager system 104 of FIG. 1 in greater detail as generating a workflow by a language model based on tasks supported by reusable workflow modules of FIG. 2. FIG. 5 depicts an example 500 of plain-language text as an input that is used to generate a prompt for processing by a language model and a workflow 116 output by the language model. FIG. 6 depicts an example 600 of a prompt for processing by a language model that includes text from a task schema. FIG. 7 depicts an example 700 of generation of an executable workflow architecture using a set of reusable workflow modules as specified by a workflow generated in FIG. 4. FIG. 8 is a flow diagram depicting an algorithm 800 as a step-by-step procedure in an example implementation of operations performable for accomplishing a result of workflow generation based on tasks supported by reusable workflow modules. In portions of the following discussion, reference is made in parallel to FIGS. 4-8.

To begin in this example, a user interface module 120 is executed by the computing device 102 to provide a user interface 126 having at least one an option configured to enter plain-language text specifying generation of a workflow to achieve a result (block 802). The option, for instance, may include a text entry box, representations of pre-built options that are selectable through use of a cursor control device, support speech-to-text translation, and so forth. In the illustrated example, the user interface module 120 supports natural language processing through use of a natural language processing module 402.

The natural language processing module 402, for instance, is configurable to leverage a machine-learning model 404 in support of a variety of functionalities. An example of which includes support of “autocomplete” functionality to text as it is entered in the user interface based on the task schema 212 describing operation of the reusable workflow modules 108. The autocomplete functionality, for instance, may be used to analyze the task schema 212 of available reusable workflow modules 108 to understand corresponding inputs, outputs, and operational parameters. As inputs are received, the natural language processing module 402 may predict and suggest relevant workflow components, parameter values, or even entire workflow sequences based on the context of the input and the capabilities of the available reusable workflow module 108. For instance, if an input begins with “analyze customer feedback,” the natural language processing module 402 may suggest relevant reusable workflow modules like sentiment analysis, topic modeling, or data visualization components that are commonly used in customer feedback workflows.

The autocomplete feature may also suggest appropriate input and output formats, recommend optimal module configurations, or highlight potential dependencies between suggested components. In this way, the natural language processing module 402 may significantly reduce the time and expertise involved in constructing complex workflows through a detailed description of what result is to be achieved and even how to achieve it, while ensuring that users leverage full capabilities of the available reusable workflow modules.

The workflow description data 122 is received as an input by a prompt manager system 124. The prompt manager system 124 then generates a prompt based on the plain-language text (block 804). The prompt manager system 124, as previously described, is configurable to generate a workflow prompt 114 for processing by the language model 112. The workflow prompt 114 is configurable in a variety of ways, such as a single prompt including an entirety of the parameters that are to be used to generate the workflow 116, as a series of prompts such that a result of processing a previous prompt may be leveraged to refine a subsequent prompt, and so forth.

In the illustrated example, for instance, the workflow prompt 114 is implemented using a series of prompts. To begin, a schema input module 406 is employed to obtain a task schema 212 describing tasks supported by respective reusable workflow modules 108, inputs, outputs, dependencies on other reusable workflow modules 108, and so forth as previously described. The task schema 212, for instance, includes information describing a component repository of reusable workflow modules for executing tasks.

A module identification module 408 is then usable to leverage the language model 112 to identify a set of reusable workflow modules 410 based on an identification prompt 412. The identification prompt 412, for instance, is configurable to include instructions to cause the language model 112 to identify which tasks and associated reusable workflow module 108 are to be used in support of achieving the result described by the workflow description data 122. The workflow description data 122, for instance, specifies usage criteria for the reusable workflow modules based on the plain-language text and then the language model 112 employs the task schema 212 to identify the set of reusable workflow modules 410 to implement that usage criteria.

The workflow description data 122, for instance, includes the following plain-language text as entered into the user interface 126 “Analyze big tech companies and store information in a spreadsheet.” The workflow manager system processes this input to generate workflow description data 122. The module identification module 408 then creates an identification prompt 412 that includes the user's request and instructions for the language model 112 to identify relevant reusable workflow modules 108. The language model 112 analyzes the prompt and the task schema 212 of available reusable workflow module 108 and identifies a set of reusable workflow modules 410 that includes components for web scraping financial data, performing sentiment analysis on news articles, creating data visualizations, and interacting with a spreadsheet API. The language model 112 selects the set of reusable workflow modules 410 in this example based on an ability to gather financial information, analyze market sentiment, and store data in a spreadsheet format, aligning with the usage criteria specified in the workflow description data 122.

An interconnection module 414 is then employed in this example to cause the language model 112 to generate an interconnection plan 416 based on an interconnection prompt 418. The interconnection prompt 418, for instance, may include the set of reusable workflow modules 410, the workflow description data 122, and the task schema 212. From this, the language module language model 112 generations interconnections between the set of reusable workflow modules 410, which may include dependency data 420 that specifies a sequence for execution of the set of reusable workflow modules 410 and may include parallelization data 422 that describes any parallel operation supported by the set of reusable workflow modules 410.

In a project management workflow, for instance, the workflow description data 122 requests creation of “a timeline for a software development project, allocate resources, and identify critical paths.” The interconnection module 414 generates an interconnection prompt 418 that includes the previously identified set of reusable workflow modules 410 (such as task scheduling, resource allocation, and path analysis modules), the workflow description data 122, and the task schema 212 for each module.

The language model 112 processes the interconnection prompt 418 and generates an interconnection plan 416. The interconnection plan 416 in this example specifies that a task scheduling module is to be executed first to create a baseline timeline, followed by a resource allocation module to assign team members to tasks. The path analysis module is then set to run in parallel with these operations, continuously updating as new information becomes available. The dependency data 420 ensures that resource allocation occurs after initial task scheduling, while the parallelization data 422 allows for simultaneous execution of the path analysis with other ones in the set of reusable workflow modules 410, optimizing the workflow's efficiency.

As part of generating the component interconnection plan 416, the component interconnection module 414 may also employ a transformation determination module 424 to instruct the language model 112 to include a transformation layer 426 as appropriate to ensure compatibility two or more of the set of reusable workflow modules 410.

In a financial analysis workflow example, an input is received to “analyze stock market data from multiple international exchanges and generate a unified report.” The component interconnection module 414 identifies the set of reusable workflow modules 410 for data retrieval from various stock exchanges, data analysis, and report generation. While generating the component interconnection plan 416 in this example, the language model 112 recognizes that the data retrieval modules for different exchanges output data in varying formats and currencies. The language model 112, based on a transformation instruction included in the interconnection prompt 418, includes a transformation layer 426 between these modules and the analysis module. This transformation layer 426 standardizes the data formats, e.g., converting financial figures to a common currency and time zone. The transformation layer 426 is also usable to harmonize naming conventions for stock symbols across different exchanges. By incorporating the transformation layer 426, the interconnection module 414 ensures that the analysis module in the set of reusable workflow modules 410 receives consistent, compatible data regardless of the source exchange. This seamless integration of diverse data sources through the transformation layer 426 enables the workflow to produce a cohesive, unified financial report without manual data reconciliation, significantly enhancing the efficiency and accuracy of the cross-exchange analysis process.

A workflow generation module 428 is then employed in this example to form a generation prompt 430 to cause the language model 112 to generate the workflow 116 (block 806). The generation prompt 430, in a first example, is formed based on the set of reusable workflow modules 410, the interconnection plan 416, the task schema 212, and the workflow description data 122 and therefore leverages previous processing performed by the language model 112. In another example, the identification prompt 412, interconnection prompt 418, and prompt 430 are unified as a single workflow prompt 114, i.e., includes instructions described for each of these prompts.

In a healthcare workflow example, a hospital administrator requests to “create a patient admission and treatment tracking system that integrates with existing electronic health records and prioritizes urgent cases.” The workflow generation module 428 formulates a generation prompt 430 that incorporates the set of reusable workflow modules 410 (including patient registration, triage assessment, EHR integration, and treatment tracking modules), the interconnection plan 416 detailing how these modules are to interact, the task schema 212 for each of the set of reusable workflow modules 410, and the workflow description data 122. The language model 112 processes this comprehensive prompt to generate a workflow 116 that seamlessly connects patient admission processes with real-time treatment tracking and EHR updates. This approach allows the language model to holistically consider each of the aspects of the workflow in a sequence of steps.

Alternatively, the prompt manager system 124 may use a unified workflow prompt 114 that combines the identification of the set of reusable workflow modules 410, interconnections, and the overall workflow structure in a single, detailed instruction set for the language model 112. In this approach, use of a single unified workflow prompt 114 allows the language model 112 to consider each of the aspects of the workflow simultaneously, potentially leading to a further optimized and cohesive solution that accounts for complex interdependencies between components. This approach may reduce a number of iterations involved in generating the workflow 116, as the language model 112 is configurable to make global optimization decisions based on a comprehensive understanding of an entirety of the result to be achieved. A variety of other examples are also contemplated.

In response, the workflow generation module 428 receives from the language model 112 the workflow 116 describing a logical order and dependencies between a set of the reusable workflow modules (block 810). The workflow generation module 428 in the illustrated example includes a testing and simulation module 432 that is usable to test operation of the 116.

The testing and simulation module 432 may execute the generated workflow 116 using a combination of historical and real-time data to validate performance and identify potential operation issues. For example, in an e-commerce order processing workflow, the testing and simulation module 432 may simulate customer orders using historical purchase patterns while incorporating real-time inventory data from the digital service provider's warehouse management system. In this way, data may be used in real time as the data is received at a digital service provider (DSP) platform. This approach allows the testing and simulation module 432 to assess how the workflow 116 handles various scenarios, such as high-volume periods or sudden changes in product availability, without disrupting actual operations.

As the simulation progresses, the testing and simulation module 432 may continuously monitor key performance indicators (KPIs) such as order processing time, error rates, and resource utilization. As part of this, the testing and simulation module 432 may inject anomalies or edge cases into the simulated data stream to test resilience and error handling capabilities of the workflow 116. For instance, testing and simulation module 432 might introduce a sudden spike in orders for a specific product category or simulate a temporary outage of a payment processing service. The testing and simulation module 432 may then analyze the response of the workflow 116 to these scenarios, identifying any bottlenecks, errors, or inefficiencies. Based on these results, the testing and simulation module 432 may provide feedback to the workflow manager system 104, potentially triggering iterative refinements to optimize the workflow's performance and reliability under various real-world conditions.

FIG. 5 depicts an example 500 of plain-language text as an input that is used to generate a prompt for processing by a language model and a workflow 116 output by the language model. The input 118 includes plain-language text specifying parameters to be used to achieve a desire result. The workflow 116 is then output in this example as text referencing the set of reusable workflow modules 410 to be used to implement the workflow 116 to achieve the result.

FIG. 6 depicts an example 600 of a prompt for processing by a language model that includes text from a task schema. In the illustrated example, the workflow prompt 114 includes the task schema 212 detailing operation of a variety of reusable workflow modules 108.

FIG. 7 depicts an example 700 of generation of an executable workflow architecture using a set of reusable workflow modules as specified by a workflow generated in FIG. 4. In this example, a visualization module 702 is employed by the workflow manager system 104 to present the workflow 116 as a visualization 704 in the user interface 126 (block 812). The visualization module 702, for instance, may process the text-based workflow 116 as shown in FIG. 5 as output by the language model 112 to create a visualization 704 as a graphical representation that visually communicates the structure and flow of the workflow. This process may involve parsing the workflow description to identify individual components, interrelationships, and execution order. The visualization module 702 may then map each component to a graphical element, such as a node or block as illustrated, and use connectors or arrows to represent the logical flow and dependencies between components. The visualization 704, for instance, may include nodes as representing a first component 706(1), a second component 706(2), a third component 706(3), a fourth component 706(4), and a transformation layer 708 connected via respective interconnections.

In creating the visualization 704, the visualization module 702 may leverage information from the component dependency data 420 and component parallelization data 422 to accurately represent sequential and parallel execution paths. The visualization module 702 may also incorporate visual cues to highlight specific aspects of the workflow, such as using different colors or shapes to distinguish between various types of components or to indicate the presence of transformation layers.

The resulting visualization 704 may be interactive, allowing users to zoom in on specific parts of the workflow, view detailed information about individual components, or even make adjustments to the workflow structure directly through the graphical interface. Thus, the visualization 704 as a visual representation may significantly enhance understanding of complex workflows and facilitate easier identification of optimization opportunities or potential issues.

The workflow manager system 104 in this example is also configurable to implement an architecture implementation module 710 to generate an executable workflow architecture 712 using the set of usable workflow modules 410 based on the workflow 116 (block 814). The executable workflow architecture 712 is executable to achieve the result itself as specified by the workflow 116 in a first example and output instructions via a user interface to achieve the result in a second example.

In a first example, a manufacturing company uses the system to generate an executable workflow architecture 706 for automating a production line. The workflow 116 created by the language model 112 includes reusable workflow modules 410 for inventory management, robotic arm control, quality assurance, and packaging. The architecture implementation module 710 translates this high-level workflow into an executable format, integrating with the company's existing industrial control systems. The resulting executable workflow architecture 706 directly controls the manufacturing process, managing the flow of materials through the production line, orchestrating the movements of robotic arms for assembly tasks, triggering quality control checks at specified intervals, and coordinating the packaging of finished products. This fully automated system operates continuously, adjusting production rates based on real-time inventory levels and order volumes, thereby achieving the result of streamlined, efficient manufacturing without direct human intervention.

In a second example, a healthcare provider implements an executable workflow architecture 712 for patient care management. The workflow 116 incorporates reusable workflow modules 410 for patient intake, diagnosis assistance, treatment planning, and follow-up scheduling. However, instead of directly executing medical procedures, this workflow is designed to guide healthcare professionals through the patient care process.

To do so, the executable workflow architecture 712 generates step-by-step instructions that are displayed via a user interface to doctors, nurses, and administrative staff. For instance, during patient intake, the executable workflow architecture 712 prompts staff to collect specific information and perform certain tests based on the patient's symptoms and medical history. For diagnosis assistance, the executable workflow architecture 712 presents relevant patient data and suggests potential diagnoses for the doctor to consider. A treatment planning module of the executable workflow architecture 712, for instance, provides evidence-based treatment options and helps schedule necessary procedures or prescriptions. Finally, a follow-up module of the executable workflow architecture 712 in this example ensures continuity of care by prompting staff to schedule future appointments and send reminders to patients.

In both examples, the executable workflow architecture 712 leverages the reusable workflow modules 410 to create a system that achieves the desired result, whether through direct automation or by providing intelligent guidance to human operators. The architecture implementation module 710 ensures that the workflow 116 generated by the language model 112 is translated into a format that is compatible with corresponding systems and interfaces, whether industrial control systems in the manufacturing example or electronic health record systems in the healthcare example. This approach allows for the creation of flexible, efficient workflows that can be adapted to a wide range of industries and use cases, which is not possible in conventional techniques.

### Example System and Device

FIG. 9 illustrates an example system generally at 900 that includes an example computing device 902 that is representative of one or more computing systems and/or devices that implement the various techniques described herein. This is illustrated through inclusion of the workflow manager system 104. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912 that stores instructions that are executable to cause the processing device 904 to perform operations. The computer-readable storage medium is configured for storing instructions that, responsive to execution by the processing device, causes the processing device to perform operations. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
providing a user interface having at least one option configured to enter plain-language text specifying generation of a workflow to achieve a result;
generating a prompt based on the plain-language text, the prompt referencing:
information describing a component repository of reusable workflow modules for executing tasks;
one or more instructions for creating the workflow; and
usage criteria for the reusable workflow modules based on the plain-language text;
receiving from a language model a workflow describing a logical order and dependencies between a set of the reusable workflow modules, the workflow received responsive to generating the prompt; and
presenting the workflow as a visualization in the user interface.

2. The method as described in claim 1, wherein the at least one option is configured to select parameter values for one or more of the reusable workflow modules.

3. The method as described in claim 1, wherein the user interface is configurable to output at least one suggestion using at least one machine-learning model using natural language processing, the at least one suggestion usable to autocomplete the plain-language text based on the usage criteria for the reusable workflow modules.

4. The method as described in claim 1, wherein:
one or more of the reusable workflow modules is associated with a task schema including definitions for expected inputs, expected outputs, or dependencies on another one of the reusable workflow modules; and
the usage criteria included in the prompt includes the task schema.

5. The method as described in claim 1, wherein the generating the prompt includes generating an identification prompt having instructions to the language model to identify the set of reusable workflow modules from the component repository.

6. The method as described in claim 1, wherein the generating the prompt includes generating an interconnection prompt having instructions to the language model to specify interconnections of the set of reusable workflow modules.

7. The method as described in claim 6, wherein the interconnections specify parallel execution of at least two reusable workflow modules in the set of reusable workflow modules.

8. The method as described in claim 6, wherein the interconnections specify at least one transformation that is executable to translate data from a first said reusable workflow module so as to be compatible with a second said reusable workflow module.

9. The method as described in claim 1, wherein the generating the prompt includes generating a generation prompt having instructions to the language model to generate the workflow, the generation prompt identifying the set of reusable workflow modules and interconnections between the set of reusable workflow modules.

10. The method as described in claim 1, wherein the generating the prompt includes instructions to the language model to generate suggestions for optimizing the workflow.

11. The method as described in claim 1, wherein the visualization depicts a sequence of tasks for achieving the result using representations of the set of reusable workflow modules and interconnections between the set of reusable workflow modules.

12. The method as described in claim 1, further comprising simulating the workflow to identify bottlenecks or errors in the workflow.

13. The method as described in claim 12, wherein the simulating is performed using data in real time as the data is received at a digital service provider (DSP) platform.

14. The method as described in claim 1, further comprising generating an executable workflow architecture including the set of the reusable workflow modules as executable to achieve the result.

15. A method comprising:
receiving via a user interface plain-language text including task description data specifying one or more tasks to be performed and definitions for expected inputs, expected outputs, or dependencies;
generating a task prompt for processing by a language model using machine learning, the task prompt based on the task description data; and
receiving a reusable workflow module from the language model, the reusable workflow module including executable code to implement a task based on the task description and including a task schema defining operation of the reusable workflow module based on the one or more task options to be performed and definitions for expected inputs, expected outputs, or dependencies.

16. The method as described in claim 15, wherein the reusable workflow module is executable to generate executable code.

17. The method as described in claim 15, wherein the reusable workflow module is executable to receive inputs via a user interface to perform the one or more tasks as part of achieving a result as part of an executable workflow architecture.

18. A computing device comprising:
a processing device; and
a computer-readable storage medium storing instructions that, responsive to execution by the processing device, causes the processing device to perform operations including:
generating a prompt based on plain-language text specifying generation of a workflow to achieve a result, the prompt referencing:
information describing a component repository of reusable workflow modules for executing tasks;
one or more instructions for creating the workflow; and
usage criteria for the reusable workflow modules; and
receiving from a language model a workflow describing a logical order and dependencies between a set of the reusable workflow modules, the workflow received responsive to generating the prompt.

19. The computing device as described in claim 18, wherein the instructions further comprise generating an executable workflow architecture including the set of the reusable workflow modules as executable to achieve the result.

20. The computing device as described in claim 18, wherein the generating the prompt includes generating:
an identification prompt including instructions to the language model to identify the set of reusable workflow modules from the component repository; and
an interconnection prompt including instructions to the language model to specify interconnections of the set of reusable workflow modules.
